(19) United States
(12) Patent Application Publication
(10) Pub. No.: US 2012/0139712 A1
(43) Pub. Date: Jun. 7, 2012

(54) HYBRID SWITCH FOR EXTENDING ANTENNA PORT AND METHOD OF CONTROLLING THE SAME, AND RFID SYSTEM USING THE HYBRID SWITCH

(75) Inventors: Jae Young JUNG, Daejeon-si (KR); Won Kyu Choi, Daejeon-si (KR); Chan Won Park, Daejeon-si (KR); Jeong Oh Kim, Uiwang-si (KR); Hyun Suk Jung, Gwangmyeong-si (KR)

(73) Assignees: EMW CO., LTD., Incheon-si (KR); ELECTRONICS AND TELECOMMUNICATIONS RESEARCH INSTITUTE, Daejeon-si (KR)

(21) Appl. No.: 13/309,933

(22) Filed: Dec. 2, 2011

(30) Foreign Application Priority Data
Dec. 6, 2010 (KR) 10-2010-0123369

(51) Int. Cl. G06K 7/01

(52) U.S. Cl. 340/10.5; 235/439

(57) ABSTRACT

A hybrid switch includes a plurality of antenna ports, a switching module for setting up a path so that a signal received from a reader passes through a designated antenna port from among the plurality of antenna ports, an antenna sense module for determining whether antennas have been attached to the plurality of antenna ports, and a communication module for processing a communication signal with the reader or a communication signal with other switch. According to the present invention, an electric wave fading zone can be obviated and RFID tags can be more efficiently recognized by increasing the number of antenna ports, without generating problems, such as the attenuation of transmission output of a reader and a reduction of the recognition ratio due to a collision between tags resulting from the constant transmission of power of the reader.

Priority to Korean patent application number 10-2010-0123369 filed on Dec. 6, 2010, the entire disclosure of which is incorporated by reference herein, is claimed.

### BACKGROUND OF THE INVENTION

1. Field of the Invention

The present invention relates to a hybrid switch and method for extending an antenna port. The present invention has been derived from researches carried out as part of the Development of IT Source Technology supported by the Ministry of Knowledge Economy (MKE) [Project Number: 2008-F-052-01, Project Name: Development of the Next-Generation RFID Technique for Item-Based Unit Application]

2. Discussion of the Related Art

In general, a Radio Frequency Identification (RFID) technique is a technique for attaching a tag to each thing, wirelessly recognizing a unique identification (ID) of the thing, and providing services, such as positioning, remote processing, and management for the thing, and the exchange of information between things, by collecting, storing, processing, and tracing corresponding information. This technique does not require direction contact like the existing barcode or scanning within a visible band. This technique is expected to replace the existing barcode because of the above advantages and being extended in its application fields. An electronic identification system of a low frequency band (30 kHz to 500 kHz) is used in a short distance of 1.8 m or less, and an electronic identification system of a high frequency band (850 MHz to 950 MHz or 2.45 GHz to 2.5 GHz) can send a signal at a long distance of 10 m or higher. That is, in an RFID system, an antenna is connected to an RFID reader, and information about RFID tags within several meters is recognized and processed.

In a conventional RFID system, RFID tags may be omitted because of an area (i.e., an electric wave fading zone) where the antennas of an RFID reader do not recognize the RFID tags owing to environmental influences when recognizing the RFID tags. This problem can be solved by using a plurality of antennas.

However, the number of antennas that can be connected to the RFID reader is only 4 on the basis of a current commercial RFID reader. Furthermore, in constructing the RFID system, the RFID reader is relatively more expensive than the antennas of the RFID reader, and the number of host PCs is also increased.

Although the number of antennas can be increased using a power divider, it may generate other problems, such as the attenuation of transmission power of the RFID reader and a collision between a plurality of tags due to the continuous transmission of power of the RFID reader.

### SUMMARY OF THE INVENTION

Accordingly, the present invention has been made keeping in mind the above problems occurring in the prior art, and an object of the present invention is to provide a hybrid switch for extending an antenna port and a method of controlling the same.

The objects of the present invention are not limited to the above-described object and other objects that have not been described will become evident to a person having ordinary skill in the art from the following description.

In accordance with a hybrid switch according to an aspect of the present invention includes a plurality of antenna ports; a switching module for setting up a path so that a signal received from a reader passes through a designated antenna port from among the plurality of antenna ports; an antenna sense module for determining whether antennas have been attached to the plurality of antenna ports; and a communication module for processing a communication signal with the reader or a communication signal with other switch.

The hybrid switch may further include a General Purpose Input/Output (GPIO) communication unit for controlling a GPIO I/O signal with the reader.

The hybrid switch further includes a power module for supplying a power source. The power module may include a first power module for rectifying control signals, received from the reader, through a DC rectification circuit and supplying the power source.

The hybrid switch further includes a power module for supplying a power source. The power module may include a second power module for rectifying a continuous wave signal supplied by the reader and supplying the power source.

The hybrid switch further includes a power module for supplying a power source. The power module may include a third power module for supplying the power source externally.

The third power module may supply the power source externally through a GPIO communication cable.

The hybrid switch may further include a control module for processing a switch control signal through the reader and a 1-line cable. The hybrid switch may further include a path selection module for selecting a path to the reader.

The hybrid switch may further include an antenna sense module for sending a DC signal to the antenna port, detecting a change of voltage, and determining whether the antennas have been attached to the antenna ports based on a result of the detection.

The hybrid switch may further include an antenna sense module for sending an AC signal to the antenna port, detecting an amount of a signal reflected from the antenna port, and determining whether the antennas have been attached to the antenna ports based on a result of the detection.

The hybrid switch may further include a control module for sending and receiving control signals to and from the reader through GPIO communication.

According to another aspect of the present invention, there is provided a method of controlling a plurality of hybrid switches connected to a reader, including performing Radio Frequency Identification (RFID) communication between the reader and a corresponding antenna port of any one of the hybrid switches and then closing the antenna port; opening an antenna port next to the any one hybrid switch; and performing RFID communication between the reader and the next antenna port and then closing the next antenna port.

The communication between the reader and the hybrid switch may be performed by setting an ID of a first hybrid switch for; the first hybrid switch setting up a communication path to a second hybrid switch, connected to the first hybrid switch, for communication with the second hybrid switch after the ID of the first hybrid switch ID is set; and setting an ID of the second hybrid switch for communication between the reader and the second hybrid switch.

Whether antennas have been attached to the antenna ports included in the hybrid switches may be determined.

Whether antennas have been attached to the antenna ports included in the hybrid switches may be determined by sending a DC signal to the antenna port and detecting a change of voltage.

Whether antennas have been attached to the antenna ports included in the hybrid switches may be determined by sending an AC signal to the antenna port and detecting an amount of a signal reflected from the antenna port.

An RFID system according to further another aspect of the present invention includes a reader configured to include a plurality of antenna ports and a plurality of hybrid switches coupled in series. Each of the hybrid switches includes a switching module coupled to each of the antenna ports and configured to set up a path so that a signal received from the reader passes through a designated antenna port from among the plurality of antenna ports, an antenna sense module configured to determine whether antennas have been attached to the antenna ports; and a communication module configured to perform communication between the reader and other connected hybrid switches.

The hybrid switch may further include a control module for processing a control signal, and a 1-line cable is connected between the reader and the hybrid switch and between the hybrid switches.

The hybrid switch may further include a GPIO communication unit for controlling a GPIO I/O signal, and a GPIO cable may be connected between the reader and the hybrid switch and between the hybrid switches.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a hybrid switch according to an embodiment of the present invention;

FIG. 2 is a diagram illustrating the path setup of the hybrid switch according to an embodiment of the present invention;

FIG. 3 shows the construction of a system in which the hybrid switch according to the embodiment of the present invention is used in a dedicated reader;

FIG. 4 is a flowchart illustrating the operation of an RFID system in which the hybrid switch according to the embodiment of the present invention is used in a dedicated reader;

FIG. 5 shows the construction of a system in which the hybrid switch according to the embodiment of the present invention is used in a commercial reader; and

FIG. 6 is a flowchart illustrating the operation of an RFID system in which the hybrid switch according to the embodiment of the present invention is used in a commercial reader.

### DETAILED DESCRIPTION OF THE EMBODIMENTS

Advantages and characteristics of the present invention, and a method for achieving them will become apparent from the following embodiments taken in conjunction with the accompanying drawings. However, the present invention is not limited to the disclosed embodiments, but may be implemented in various different ways. The embodiments are provided to complete the disclosure of the present invention and to allow a person having ordinary skill in the art to fully understand the scope of the present invention. The present invention is defined by the category of the claims. Meanwhile, terms used in the present specification are used to describe the embodiments and not intended to limit the present invention.

Hereinafter, a hybrid switch according to an embodiment of the present invention is described in detail.

The hybrid switch according to the embodiment of the present invention may be compatible with both a dedicated reader and a commercial reader. In the case where a hybrid dedicated reader is used, a command is issued to all switches through 1-line cable communication. The hybrid dedicated reader may further include a control unit for processing a command, such as state information about a hybrid switch, so that it can receive the state information of the hybrid switch.

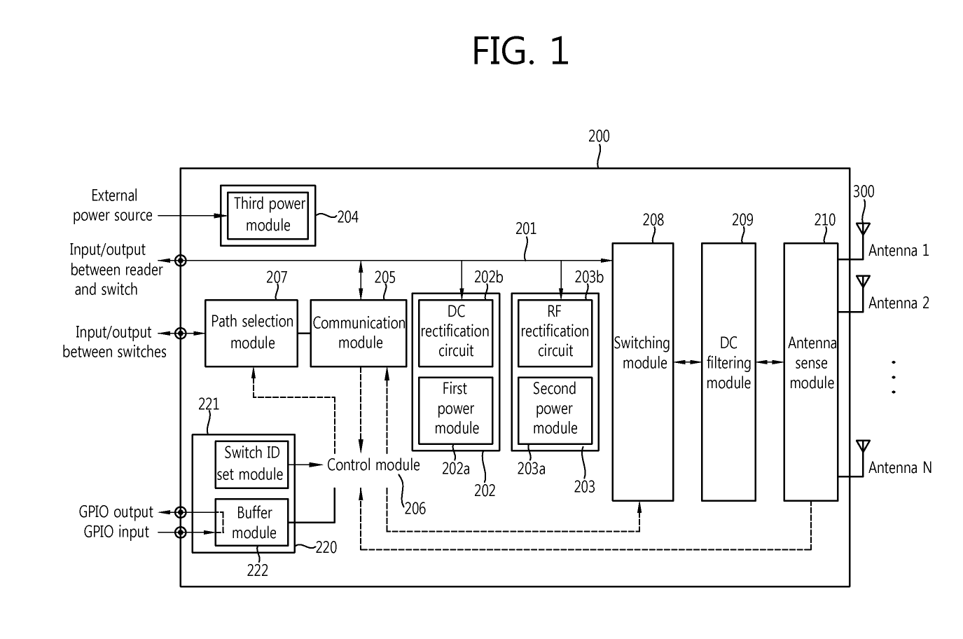

FIG. 1 is a block diagram of the hybrid switch according to the embodiment of the present invention.

As shown in FIG. 1, the hybrid switch 200 according to the embodiment of the present invention includes a 1-line cable 201. The 1-line cable 201 may be an RF cable for connecting an RFID reader and the hybrid switch 200.

A hybrid dedicated reader provides a hybrid switch control signal and the hybrid switch 200 sends internal state information to the hybrid dedicated reader, through the 1-line cable 201. Furthermore, the hybrid switches 200 are connected by the 1-line cable 201.

A DC power supply unit 202, an RF power supply unit 203, and a communication module 205 are connected to the 1-line cable 201 within the hybrid switch 200.

The DC power supply unit 202 includes a first power module 202a and a DC rectification circuit 202b. The first power module 202a constantly supplies DC power to the hybrid switch 200 when the hybrid dedicated reader is in a standby state and provides a signal of a high or low level when it sends a control signal to the hybrid switch 200. Furthermore, the first power module 202a supplies the control signal, received from the hybrid dedicated reader, to the hybrid switch 200 through the DC rectification circuit 202b as a stable power source and sends a DC signal for a hybrid switch power source with it carried on a continuous wave signal, received from the hybrid dedicated reader, when the hybrid dedicated reader communicates with a tag.

The RF power supply unit 203 includes a second power module 203a and an RF rectification circuit 203b. The second power module 203a may send a power source obtained by rectifying a continuous wave signal, received from a commercial reader, through the RF rectification circuit 203b. For example, a 900 MHz reader may send power of 1 W. The transmission power of 1 W is enough to drive the hybrid switch 200.

The hybrid switch 200 may further include a third power module 204 other than the first power module 202a and the second power module 203a. The third power module 204 functions to supply an external power source to the hybrid switch 200 and to constantly supply a stable power source. In case of a commercial reader, the third power module 204 may supply the power source through a General Purpose Input/Output (GPIO) communication cable.

The communication module 205 is chiefly used when it communicates with the hybrid dedicated reader, and it basically includes a transmission unit and a reception unit. The reception unit of the communication module 205 provides a control module 206 with the hybrid switch control signal of the hybrid dedicated reader. The transmission unit of the communication module 205 transfers a switch port state information signal from the hybrid switch 200 to the hybrid dedicated reader.

The switch port state information may include switch ID information and antenna sense information. The hybrid dedicated reader sends an RF signal to only an antenna port, corresponding to a specific switch, on the basis of the switch ID information and the antenna sense information and performs communication with a tag through the antenna port.

The control module 206 enters a normal state since the power source is supplied by the first power module 202a. The control module 206 sends a hybrid switch control signal to the hybrid dedicated reader and the elements within the hybrid switch through the communication module 205. A path selection module 207 is controlled by the control module 206 and configured to determine the direction of an I/O signal between the hybrid switches.

Furthermore, the hybrid switch according to the embodiment of the present invention further includes a switching module 208 connected to the 1-line cable 201, a DC filtering module 209 connected to the switching module 208, and an antenna sense module 210 connected to the DC filtering module 209. A plurality of antenna ports is included in the antenna sense module 210, and an antenna 300 may be connected to each of the antenna ports.

The switching module 208 functions to set up a path so that a signal received from the antenna port of the hybrid dedicated reader passes through a designated antenna port from among the plurality of antenna ports included in the hybrid switch 200. The DC filtering module 209 functions to remove DC signal components from a signal received from the antenna port received from the hybrid dedicated reader. The antenna sense module 210 functions to determine whether the antenna 300 has been attached to the antenna port of the hybrid switch 200.

The hybrid switch 200 according to the embodiment of the present invention further includes a GPIO communication unit 220 for communication with a commercial reader. The GPIO communication unit 220 includes a switch ID set module 221 and a buffer module 222.

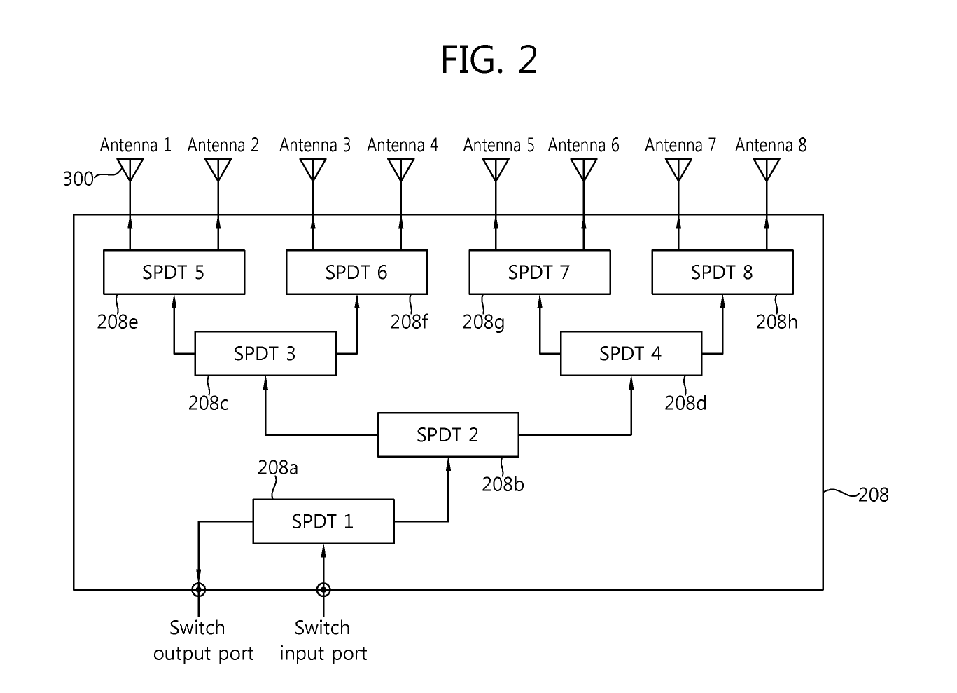

Meanwhile, FIG. 2 shows an embodiment of the switching module within the hybrid switch according to the embodiment of the present invention.

The switching module 208 of the present embodiment corresponds to a case where one input is extended to eight antenna ports. Paths to antenna ports are set up by eight Single Pole Double Throws (SPDT) 208a to 208h, respectively. As shown in FIG. 2, the SPDT 1 208a functions to transfer a reader signal to a corresponding hybrid switch 200. The SPDT 2 208b to the SPDT 8 208h function to selectively extent one input port to eight ports through the selection of paths within the hybrid switch 200.

The following table shows an example of the operation of the switching module 208.

TABLE

| Antenna Port | SPDT 1 | SPDT 2 | SPDT 3 | SPDT 4 | SPDT 5 | SPDT 6 | SPDT 7 | SPDT 8 |
|---|---|---|---|---|---|---|---|---|
| 1 | RIGHT | LEFT | LEFT | X | LEFT | X | X | X |
| 2 | RIGHT | LEFT | LEFT | X | RIGHT | X | X | X |
| 3 | RIGHT | LEFT | RIGHT | X | X | LEFT | X | X |
| 4 | RIGHT | LEFT | RIGHT | X | X | RIGHT | X | X |
| 5 | RIGHT | RIGHT | X | LEFT | X | X | LEFT | X |
| 6 | RIGHT | RIGHT | X | LEFT | X | X | RIGHT | X |
| 7 | RIGHT | RIGHT | X | RIGHT | X | X | X | LEFT |
| 8 | RIGHT | RIGHT | X | RIGHT | X | X | X | RIGHT |
| Others | LEFT | X | X | X | X | X | X | X |

Embodiments of an RFID system, applied to the hybrid switch according to the embodiment of the present invention, a hybrid dedicated reader, and a commercial reader, are described below.

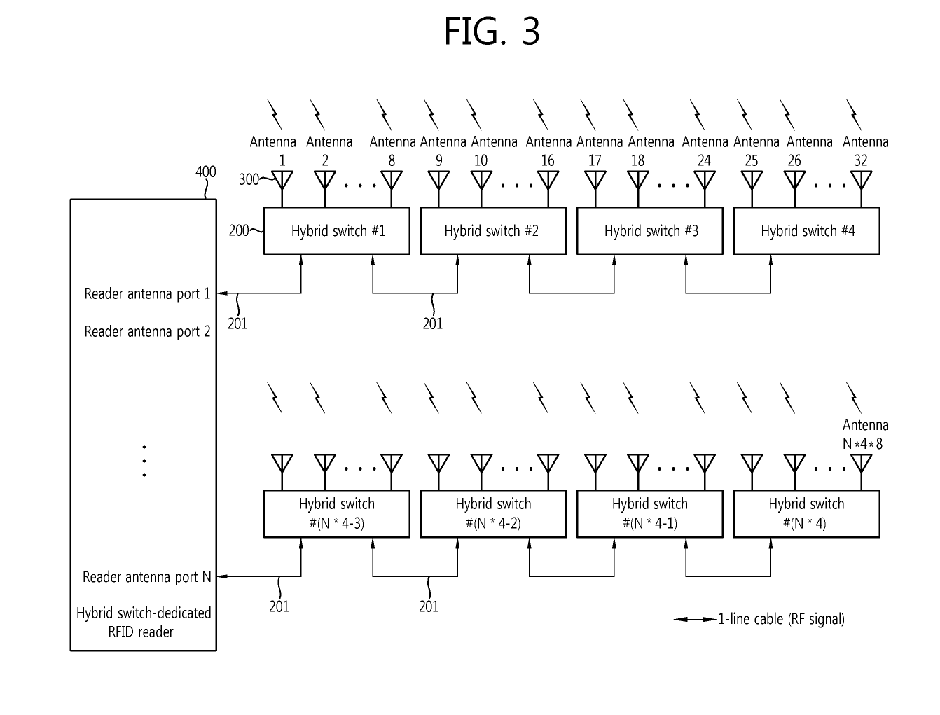

FIG. 3 shows the construction of a system in which the hybrid switch according to the embodiment of the present invention is used in the dedicated reader.

The embodiment of FIG. 3 shows a construction in which the four hybrid switches 200 are connected to each of the antenna ports of the dedicated reader 400. Each of the hybrid switches 200 has eight antenna ports. If the number of antenna ports of the dedicated reader 400 is N (N is a positive integer greater than 1), the number of antenna ports that may be included in one dedicated reader 400 is a maximum of N*4*8.

For example, assuming that the number of antenna ports of the dedicated reader 400 is 8, a total of the 32 hybrid switches 200 may be connected to the dedicated reader 400, and thus the number of antenna ports of the hybrid switches 200 may become 256. For the purpose of the above description, in the embodiment of FIG. 3, only the hybrid switch #1 connected to the antenna port 1 of the dedicated reader 400 is indicated by a symbol ‘200 ’, and the remaining hybrid switches are indicated by ‘#2 to #N*4’.

Meanwhile, in the embodiment of FIG. 3, the hybrid switches 200 connected to the dedicated reader 400 do not require additional hybrid switch control lines and power lines other than a 1-line cable (i.e., RF signal) 201. Accordingly, the construction of the entire system can be simplified, and the cost for constructing the system can be reduced.

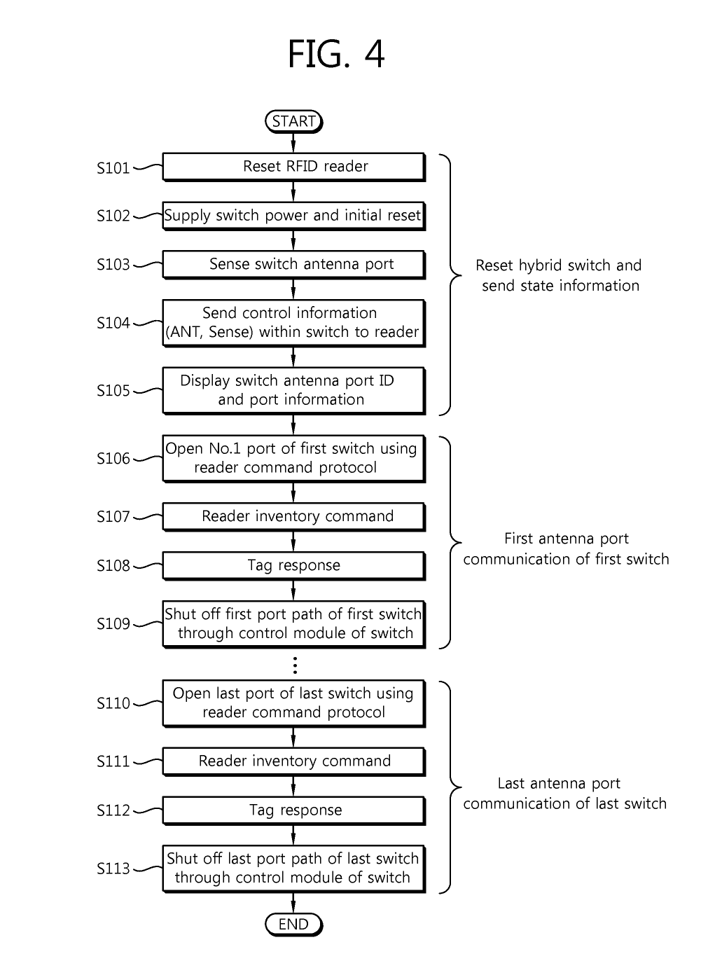

FIG. 4 is a flowchart illustrating the operation of an RFID system in which the hybrid switch according to the embodiment of the present invention is used in the dedicated reader.

As shown in FIG. 4, when the hybrid switch 200 is used in the dedicated reader 400, the operation of the RFID system includes a hybrid switch reset and state information transmission process S101 to S104 for communication between the dedicated reader 400 and tags, a No. 1 antenna port communication process of the first hybrid switch 200 S106 to S109, and a communication process S110 to S113 up to the last antenna port of an ‘N*4’ (N is a positive integer greater than 1) hybrid switch or the last hybrid switch.

First, the reset and state information transmission process of the hybrid switch 200 is described. The dedicated reader 400 is reset for communication with the hybrid switch 200 at step S101. The dedicated reader 400 sends a hybrid switch control signal to the hybrid switch 200 through the 1-line cable 201.

The hybrid switch 200 that has received the hybrid switch control signal supplies a power source through DC rectification, and a plurality of hybrid switch ID set values is reset at step S102. That is, the hybrid switches 200 may be initially set to the same default ID.

Accordingly, when the dedicated reader 400 attempts to communicate with the hybrid switch 200 having a default ID, at a first step, only the first hybrid switch #1 responds to the attempt. Thereafter, the first hybrid switch #1 may be set to an ID having another value (e.g., 0×01), and a path to a next hybrid switch is established by the path selection module 207.

At a second step, the dedicated reader 400 attempts to communicate with the second hybrid switch #2. If the switch ID value of the second hybrid switch #2 is a default ID value, the second hybrid switch #2 is set to an ID having another value (e.g., 0×02), and then a path to a next hybrid switch #(N*4) is established by the path selection module 207.

Here, the first and second hybrid switches are on the same loop, but only the second hybrid switch responds to the communication attempt because the ID of the first hybrid switch has already been changed.

Likewise, the hybrid switches 200 of next steps are assigned new IDs, and signal paths are sequentially established. After the switch IDs are assigned, all communication is performed using the new IDs. The newly assigned switch IDs are sent to the dedicated reader 400. The dedicated reader 400 can check the number of switches attached per reader port. This process is performed up to the last hybrid switch.

When the IDs of the hybrid switches 200 attached to the antenna ports of the dedicated reader 400 are determined through the above process, the dedicated reader 400 performs an antenna port sense process in order to determine whether the antenna 300 has been attached to the hybrid switch 200 at step S103.

When an antenna sense command is received from the dedicated reader 400, the hybrid switch 200 determines whether the antenna 300 has been attached thereto through the antenna sense module 210 of the hybrid switch 200 and sends corresponding information to the dedicated reader 400. Here, the antenna sense module 210 may be implemented in two kinds.

In the first implementation, the control module 206 may determine whether the antenna 300 has been attached to the hybrid switch 200 by sending a specific DC signal to an antenna port and detecting a change of voltage. For example, when the control module 206 sends a specific DC signal to an antenna port of the hybrid switch 200, if the antenna 300 has been designed to generate low resistance in terms of DC in the case where the antenna 300 is attached to the antenna port, a signal supplied to the control module 206 may sharply drop.

On the other hand, in the case where the antenna 300 is not attached to the antenna port of the hybrid switch 200, there is no change of the signal supplied to the control module 206. The hybrid switch 200 can determine whether the antenna 300 has been attached to the antenna port on the basis of the information.

In the second implementation, whether an antenna has been attached to an antenna port may be determined by sending a specific AC signal to the antenna port and detecting the amount of a signal reflected therefrom. For example, when the control module 206 sends a specific AC signal to an antenna port of the hybrid switch 200, if the antenna 300 has been designed to be impedance-matched in terms of AC when the antenna 300 is attached to the antenna port of the hybrid switch 200, the amount of a reflected signal is small. However, if the antenna 300 is not attached to the antenna port of the hybrid switch 200, the amount of the reflected signal is relatively great.

The hybrid switch 200 according to the embodiment of the present invention can determine whether the antenna 300 has been attached to the antenna port on the basis of the information.

After whether the antenna 300 has been attached to the antenna port of the hybrid switch 200 is determined as described above, the hybrid switch 200 according to the embodiment of the present invention sends the pieces of control information to the dedicated reader 400 through the control module 206 at step S104. Accordingly, the dedicated reader 400 can have information about the ID of the hybrid switch 200 attached to the antenna port and about whether the antenna 300 has been attached to the antenna port. The dedicated reader 400 displays an antenna port ID of the hybrid switch 200 and port information to a user at step S105.

After the above process is finished, the dedicated reader 400 performs a process of communicating with tags by sequentially designating the antenna ports of the hybrid switch 200 and sending a dedicated reader command through a corresponding port. Through the repetitive process, the dedicated reader 400 can recognize a plurality of tags through all the antennas attached to the antenna ports of the hybrid switch 200 without extending the dedicated reader.

That is, the dedicated reader 400 establishes the No. 1 antenna port path of the first hybrid switch 200 at step S106. Next, the dedicated reader 400 sends a reader inventory command through the No. 1 antenna port of the first hybrid switch 200 at step S107 and communicates with a tag when the tag responds thereto at step S108. Next, the dedicated reader 400 shuts off the corresponding antenna port path at step S109. Through the above process, the dedicated reader 400 performs communication, such as that described above, with the last antenna port at steps S110 to S112. When the communication with the last antenna port is terminated, the entire communication process with the tags is terminated at step S113.

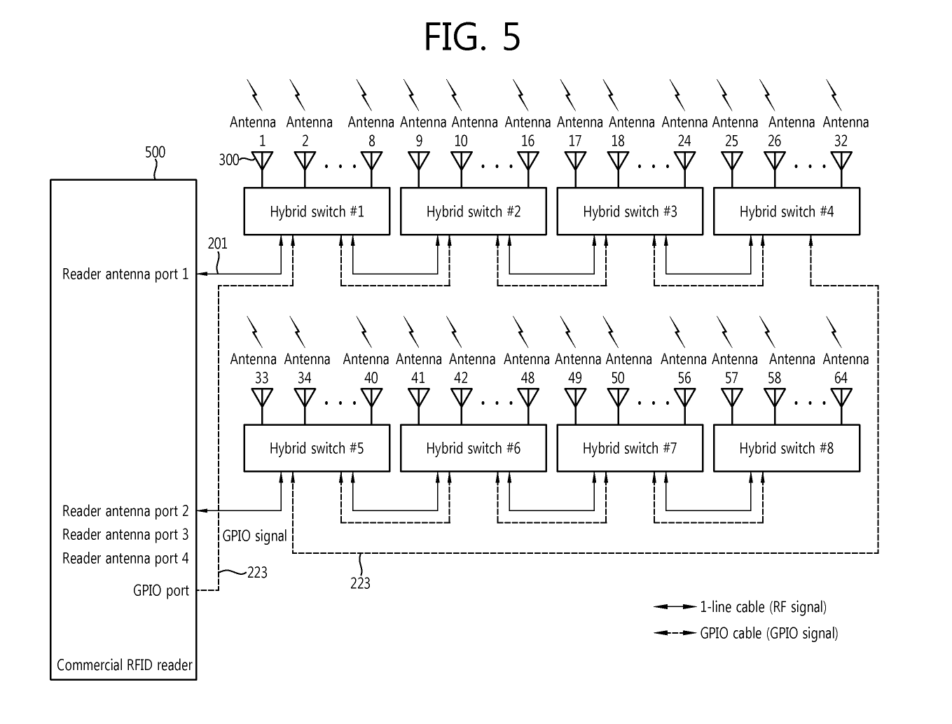

FIG. 5 shows the construction of a system in which the hybrid switch according to the embodiment of the present invention is used in the commercial reader.

As shown in FIG. 5, the commercial reader 500 typically has four antenna ports and has a GPIO port for various service extensions. The hybrid switch 200 according to the embodiment of the present invention is operated in conjunction with the commercial reader 500 through GPIO communication.

The four hybrid switches 200 may be connected to the commercial reader 500 per antenna port. Each of the hybrid switches 200 may have eight antenna ports. Accordingly, if the number of antenna ports of the commercial reader 500 is four, the number of antenna ports that may be included in one commercial reader 500 may be a maximum of 128=4*4*8. FIG. 5 shows a case where the first hybrid switch #1 is indicated by a representative symbol 200 and the remaining hybrid switches are indicated by #1 to #8.

The commercial reader 500, as shown in FIG. 5, further includes a 1-line cable (RF cable) and a GPIO cable 223 for controlling the hybrid switch 200. The GPIO cable 223 for GPIO communication may be an Ethernet cable. The commercial reader 500 and each of the hybrid switches, and the hybrid switches are connected to the GPIO cable 223. However, a power line is not required. Accordingly, the system can be operated in conjunction with the exiting commercial reader (500) system, and the cost for constructing a system can be reduced by extending the antenna ports of an RFID reader using the hybrid switch 200.

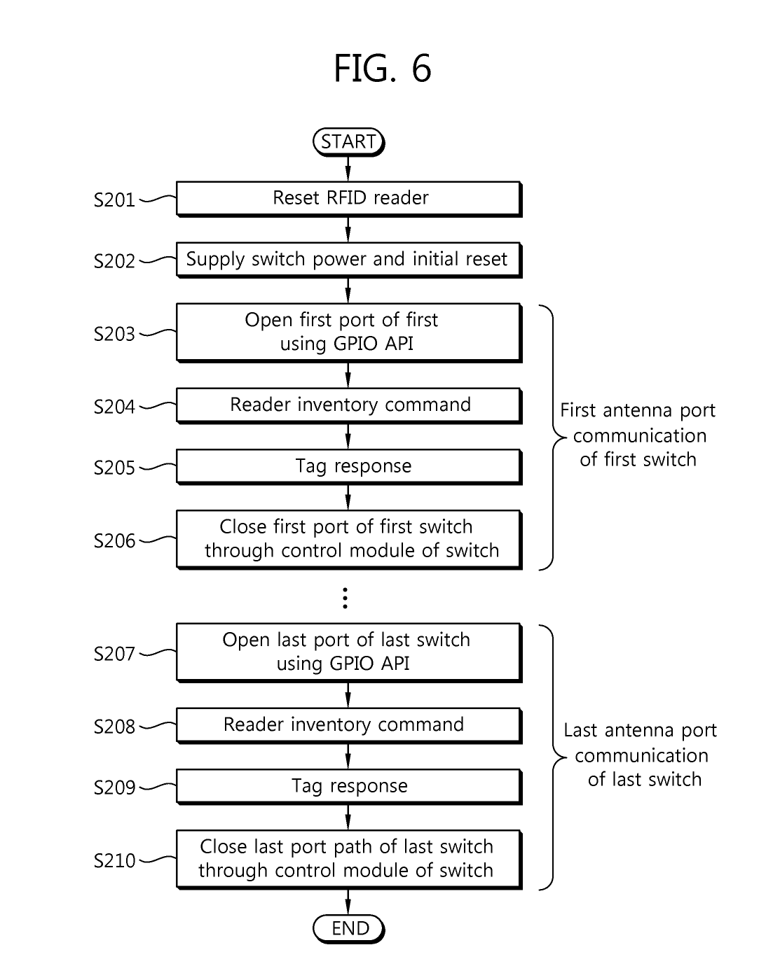

FIG. 6 is a flowchart illustrating the operation of an RFID system in which the hybrid switch according to the embodiment of the present invention is used in a commercial reader.

A major difference between the operations of the RFID systems using the commercial reader 500 and the dedicated reader 400 is that the commercial reader 500 sends a control command to all the hybrid switches 200 through GPIO communication, but does not receive state information about the hybrid switches 200 unlike the dedicated reader 400. This is because the commercial reader 500 does not include a control unit for processing a command for the state information of the hybrid switches 200.

Accordingly, unlike the system using the dedicated reader, the commercial reader 500 experiences a different reset process from the RFID reader reset process performed in the dedicated reader. The RFID reader reset process S201 in the commercial reader 500 refers to GPIO communication reset for communication with the hybrid switches 200.

After the RFID reader reset process is performed, a hybrid switch power supply and reset process is performed at step S202. The hybrid switch power supply and reset process includes a process of the commercial reader 500 supplying a hybrid switch power supply signal through a 1-line cable 201 and a process of the hybrid switch 200 that has received the hybrid switch power supply signal supplying a power source through AC rectification.

Here, all the hybrid switches 200 communicating with the commercial reader 500 are initially set to an ID designated upon initial state, and they have a unique ID which has been previously designated by the switch ID set module 222 of the GPIO communication unit 220. For example, if the switch ID set module is set to a 5-bit hardware switch, the hybrid switches 200 may be represented by 32 different IDs.

Accordingly, the commercial reader 500 may communicate with the hybrid switch 200 having the same switch ID set module value which has been previously designated through GPIO communication with the hybrid switch 200. Here, the hybrid switch control command signal of the commercial reader 500 may be lost according to the number of switches and the extension of a path. In order to compensation for the loss, the buffer module 222 is embedded in a GPIO communication unit.

This process is described in more detail below. A switch ID signal, from among the GPIO communication control signals of the commercial reader 500, is decrypted by the control module 206 of the hybrid switch 200. If the decrypted value is identical with a switch ID set module value, the commercial reader 500 communicates with a plurality of tags through the corresponding hybrid switch 200.

If a switch ID signal, from among the GPIO communication control signals of the commercial reader 500, is not identical with a switch ID set module value, the GPIO communication control signals are sent to a next hybrid switch 200 through the GPIO output port of the hybrid switch 200, and the above process is repeated.

For example, assuming that the GPIO communication control signal of the commercial reader 500 has a form of 8 bits, if the upper 5 bits of the 8 bits are designated as a switch ID set signal and the lower 3 bits of the 8 bits are designated as an antenna port set signal within the hybrid switch 200, the number of hybrid switches 200 which can communication with the commercial reader 500 is 32, and the number of antenna ports within each of the hybrid switches 200 is 8. Consequently, a total of the 256 antenna ports can be attached to one of the antenna ports of the commercial reader 500.

Next, the commercial reader 500 establishes a path to the No. 1 antenna port of the first hybrid switch 200 through a GPIO API at step S203 and sends a reader inventory command through the No. 1 antenna port of the first hybrid switch 200 at step S204. Accordingly, when peripheral RFID tags respond to the reader inventory command, the commercial reader 500 communicates with the tags at step S205. Next, the commercial reader 500 shuts off the corresponding antenna port path through the control module 206 of the hybrid switch 500 at step S206.

Through the above process, the commercial reader 500 performs communication, such as that described above, with the last antenna port. When the communication with the last antenna port is completed, the entire communication process with the tags is terminated at steps S207 to S210.

In accordance with the hybrid switch for extending an antenna port and the method of controlling the same according to the present invention, an electric wave fading zone can be obviated and RFID tags can be more efficiently recognized by increasing the number of antenna ports, without generating problems, such as the attenuation of transmission output of a reader and a reduction of the recognition ratio due to a collision between tags resulting from the constant transmission of power of the reader. Accordingly, the hybrid switch of the present invention is advantageous in that an RFID system can be constructed, even without using an expensive reader and increasing the number of host PCs.

Furthermore, if the RFID reader dedicated to the hybrid switch is used, a 1-line cable can be wired without a switch power line and a switch control signal line. Accordingly, there are advantages in that the system can be simplified and the cable expenses can be reduced.

Furthermore, since the hybrid switch of the present invention is compatible with the existing commercial RFID reader, a dedicated RFID reader needs not to be constructed in order to use the hybrid switch according to the present invention. Accordingly, there is an advantage in that the cost for constructing an RFID system can be reduced.

While the invention has been shown and described with respect to the preferred embodiments, it will be understood by those skilled in the art that various changes and modifications may be made without departing from the spirit and scope of the invention as defined in the following claims.

What is claimed is:

1. A hybrid switch, comprising
a plurality of antenna ports;
a switching module for setting up a path so that a signal received from a reader passes through a designated antenna port from among the plurality of antenna ports;
an antenna sense module for determining whether antennas have been attached to the plurality of antenna ports; and
a communication module for processing a communication signal with the reader or a communication signal with other switch.

2. The hybrid switch as claimed in claim 1, further comprising a General Purpose Input/Output (GPIO) communication unit for controlling a GPIO I/O signal with the reader.

3. The hybrid switch as claimed in claim 1, further comprising a power module for supplying a power source, wherein the power module comprises a first power module for rectifying control signals, received from the reader, through a DC rectification circuit and supplying the power source.

4. The hybrid switch as claimed in claim 1, further comprising a power module for supplying a power source, wherein the power module comprises a second power module for rectifying a continuous wave signal supplied by the reader and supplying the power source.

5. The hybrid switch as claimed in claim 1, further comprising a power module for supplying a power source, wherein the power module comprises a third power module for supplying the power source externally.

6. The hybrid switch as claimed in claim 5, wherein the third power module supplies the power source externally through a GPIO communication cable.

7. The hybrid switch as claimed in claim 1, further comprising a control module for processing a switch control signal through the reader and a 1-line cable.

8. The hybrid switch as claimed in claim 1, further comprising a path selection module for selecting a path to the reader.

9. The hybrid switch as claimed in claim 1, further comprising an antenna sense module for sending a DC signal to the antenna port, detecting a change of voltage, and determining whether the antennas have been attached to the antenna ports based on a result of the detection.

10. The hybrid switch as claimed in claim 1, further comprising an antenna sense module for sending an AC signal to the antenna port, detecting an amount of a signal reflected from the antenna port, and determining whether the antennas have been attached to the antenna ports based on a result of the detection.

11. The hybrid switch as claimed in claim 1, further comprising a control module for sending and receiving control signals to and from the reader through GPIO communication.

12. A method of controlling a plurality of hybrid switches connected to a reader, the method comprising:
performing Radio Frequency Identification (RFID) communication between the reader and a corresponding antenna port of any one of the hybrid switches and then closing the antenna port;
opening an antenna port next to the any one hybrid switch; and
performing RFID communication between the reader and the next antenna port and then closing the next antenna port.

13. The method as claimed in claim 12, wherein the communication between the reader and the hybrid switch is performed by:
setting an ID of a first hybrid switch for;
the first hybrid switch setting up a communication path to a second hybrid switch, connected to the first hybrid switch, for communication with the second hybrid switch after the ID of the first hybrid switch ID is set; and
setting an ID of the second hybrid switch for communication between the reader and the second hybrid switch.

14. The method as claimed in claim 13, wherein whether antennas have been attached to the antenna ports included in the hybrid switches is determined.

15. The method as claimed in claim 14, wherein whether the antennas have been attached to the antenna ports is determined by sending a DC signal to the antenna port and detecting a change of voltage.

16. The method as claimed in claim 14, wherein whether the antennas have been attached to the antenna ports is determined by sending an AC signal to the antenna port and detecting an amount of a signal reflected from the antenna port.

17. An RFID system, comprising:
a reader configured to include a plurality of antenna ports; and
a plurality of hybrid switches coupled in series,
wherein each of the hybrid switches comprises:
a switching module coupled to each of the antenna ports and configured to set up a path so that a signal received from the reader passes through a designated antenna port from among the plurality of antenna ports,
an antenna sense module configured to determine whether antennas have been attached to the antenna ports; and
a communication module configured to perform communication between the reader and other connected hybrid switches.

18. The RFID system as claimed in claim 17, wherein the hybrid switch further comprises a control module for processing a control signal, wherein a 1-line cable is connected between the reader and the hybrid switch and between the hybrid switches.

19. The RFID system as claimed in claim 18, wherein the hybrid switch further comprises a GPIO communication unit for controlling a GPIO I/O signal, wherein a GPIO cable is connected between the reader and the hybrid switch and between the hybrid switches.
